(19) United States
(12) Patent Application Publication
(10) Pub. No.: US 2004/0074917 A1
(43) Pub. Date: Apr. 22, 2004

(54) Tamper and child proof tablet dispenser with ejection means

(76) Inventor: Roy Neil McHutchinson, South Perth (AU)

Correspondence Address: MERCHANT & GOULD PC, P.O. BOX 2903, MINNEAPOLIS, MN, 55402-0903, US

(21) Appl. No.: 10/344,471

(22) PCT Filed: Aug. 10, 2001
(86) PCT No.: PCT/AU01/00982

(51) Int. Cl. A47F 1/04; G07F 11/16

(52) U.S. Cl. 221/302

(57) ABSTRACT

Tamper and child proof dispenser for a solid dosage product such as tablets and capsules that may be contained in a blister sheet. Dispenser comprises a dispensing assembly (3) for holding and dispensing the product, a slidably or hingedly connected outercover (1) for covering the assembly to prevent access to the product, and tamper indication means (7) of an elongate removable tag for indicating a prior displacement of the outer cover. The dispenser has an external child proof button (9) supported on a tongue (10). The dispensing assembly has an ejection means of a slide actuation mechanism (57) including an actuation arm (59) upon which is mounted a slidable rider member (61) with an abutment to engage and eject the solid dosage product. The outer cover has four separable portions (67) which are individually removed to enable a particular actuation mechanism (57) to be moved for dispensing a product.

The present invention is generally directed to packaging and dispensing systems, and in particular to tamper proof dispensers suitable for products such as medicinal tablets or capsules. Although the present invention will be described with respect to such products, it is to be appreciated the invention is also applicable for dispensing other types of products.

Products of the above mentioned type are commonly sold in cardboard cartons, with the tablets or capsules individually sealed in a bubble wrapped sheet. This form of packaging provides a long shelf life for the product as they are individually placed in an air tight seal. Furthermore, this type of packaging provides for more hygienic storage of the product. These cartons can be covered by heat wrapped plastic sheeting to afford a limited degree of tamper prevention by preventing the opening of the carton to gain access to the contents without tearing of the plastic wrapping. The tearing of the wrapping provides a visual indication that the packaging has been opened. This type of wrapping does not however prevent a more malicious form of tampering where the products are dosed with foreign substances such as poison by using a syringe needle. The hole produced by the needle can be located to escape notice so that the tampering of the product remains undetected.

Although such malicious tampering could be overcome by enclosing the product in a hard casing, it has until now been uneconomical to do so as it would add significantly to the overall selling cost of the product. Also, such a hard casing could well be difficult to open by the final end user of the product.

Another issue with such packaging is that a child can gain ready access to the contents of the carton when opened. There is no way to child proof such a carton after it has been opened. Although containers having child proof lids can be used, such containers do not provide an air tight seal for the product contained therein once the container is opened. This can result in the subsequence contamination of the product by bacteria or other substances. It is therefore advantageous to be able to maintain the product in an air tight seal until immediately prior to use. It would also be advantageous to be able to dispense the product without having to physically touch the product to further minimise any contamination of that product.

It is therefore an object of the present invention to provide a dispenser for products such as tablets or drugs that overcomes one or more of the abovenoted disadvantages associated with known containers.

With this in mind, there is provided a tamper proof dispenser for a solid dosage product including:

dispensing assembly for holding and dispensing the product;

an outer cover for covering at least a portion of the dispensing assembly to thereby prevent access to the product stored therein; and

tamper indication means for indicating a prior displacement of the outer cover.

The dispenser may further include child proofing means for preventing a child from readily moving the cover thereby preventing access to the product contained therein.

The term “solid dosage product” is used to describe products in tablet, capsule or other compact forms.

The dispenser according to the present invention may accommodate at least one conventional twenty or twenty four solid dosage product bubble wrapped sheet. These types of sheets are commonly used to package medicinal tablets or capsules in a sealed state within a cardboard container. To this end, the dispenser may have a generally rectangular shape when seen in plan view. The dispenser may contain at least one said bubble wrapped sheet therein. It is however also envisaged that the dispenser may accommodate naked solid dosage products without any bubble wrapping. The dispenser may also be of an alternative shape as it is not restricted to the conventional rectangular shape of the bubble wrapped sheet. The dispenser may for example be cylindrical in shape, with the outer cover being cylindrical in shape and located over a central dispensing means for the product.

According to one preferred embodiment of the present invention, the outer cover may substantially enclose the dispensing assembly and may be slidably supported over the dispensing assembly. The tamper indication means may prevent sliding motion of the cover over the dispensing assembly which will allow access to the product located therein. According to this preferred embodiment, the tamper indication means may be in the form of a removable part of the outer cover, the removable part being coupled to or partially secured to the dispensing assembly. The separation of the removable part releases the outer cover from the dispensing assembly allowing relative movement therebetween as well as providing a visual indication that the dispenser has been opened. The removable part may be in the form of an elongate tag, at least a portion of the opposing sides of the tag being secured to the outer cover. The tag may be secured to the outer cover by a frangible membrane. The tag may be formed integrally with the outer cover or may be subsequently secured to the outer cover. One end of the elongate tag is provided with a raised ledge that is positioned away from an outer surface of the outer cover. This ledge provides a means whereby a person can lift the end of the tag away from the rest of the dispenser to thereby separate the rest of the tag therefrom. The opposing end of the elongate tag is coupled to the dispensing assembly and is uncoupled therefrom when the elongate tag is removed from the dispenser. The opposing end of the elongate tag may for example be located under an undercut provided on the dispensing assembly. The relative movement of the outer cover and dispensing assembly is therefore prevented until such times as the elongate tag is uncoupled from the dispensing assembly.

Child proofing means may be provided to prevent the dispenser being readily opened by a child after the tamper indication means has been removed. To this end, the child proofing means may include a button mounted on the end of a tongue. The other end of the tongue may be hingedly connected to the rest of the dispensing assembly. The child proofing means may further include means for engaging the outer cover. The engagement means could for example be in the form of a male lug provided on an inner surface of the outer cover, with a cooperating aperture or cavity being provided in the tongue. The lug is captured within the aperture or cavity in the tongue when the cover is closed over the dispensing assembly. Pivotal displacement of the tongue away from the lug by applying a lateral force on the button releases the aperture or cavity of the tongue from the lug thereby allowing movement of the cover over the dispensing assembly. The lateral motion of the button required to release the child proofing means would typically not be comprehended by a young child who would more likely simply try to pull the cover off the dispensing assembly.

The opposing end of the elongate tag of the tamper indication means may be located under an edge of the button to prevent movement thereof until such times as the elongate band is separated from the outer cover.

As hereinbefore noted, the dispensing assembly may be adapted to accommodate at least one said bubble wrap sheet containing the solid dosage product. To this end, the dispensing assembly may include an outer shell for accommodating one or more of these sheets. Each sheet typically includes a plastic membrane having a plurality of depressions to provide a cavity within which each solid dosage product is respectively located. An aluminum foil covers the plastic membrane to thereby seal the product therein.

A plurality of openings may be provided through the outer shell through which the product may exit the dispensing means. The or each bubble wrapped sheet may be located within the shell, with the foil side of the sheet facing the openings, these openings being aligned with a respective cavity of the sheet. Preferably two said sheets may be accommodated within the shell, with the said openings being on opposing sides of the shell. the plastic membrane side of each sheet facing inwardly towards each other, the foil side of each sheet facing the openings in the outer shell. When the outer cover is located in a “closed” position over the dispensing assembly, all of the openings may be covered by the outer cover.

It is however also envisaged that “naked” or unpackaged product may be accommodated within the dispensing assembly. To this end, a membrane may be located over each opening to prevent the product dropping out prematurely from the dispensing assembly. The product can also be loaded into the dispenser in a vacuum which helps to prevent bacteria contamination of the product.

The dispensing assembly may further include an ejection means for ejecting the solid dosage product therefrom. The ejection means may include at least one slide mechanism including an actuation arm upon which is slidably mounted a rider member. Two said actuation arms may preferably be located side by side adjacent a said bubble wrapped sheet where that sheet accommodates two rows of product. Therefore, a total of four said slide mechanisms may be located within the outer shell of the dispensing assembly, two at each side of the dispensing assembly when there are two bubble wrapped sheets accommodated therein. These actuation arms may be slidably supported by an inner support frame located within the outer shell.

An abutment may extend from the rider member, this abutment being for example in the form of a wedge or ramp. The actuation arm may move both forward and backwards in a direction parallel to the elongate axis thereof. The motion of the actuation arm may move the rider member and urge the abutment of the rider member against a product located within a bubble wrap sheet to thereby eject that product out from the bubble, through the foil and out of the shell opening located adjacent the bubble to thereby dispense that product therefrom. Alternatively, the rider member may urge an intermediate abutment arrangement that then engages the product located within the bubble wrap sheet.

The bubble wrap sheet may be located on a support plate having a plurality of apertures allowing the bubble of the sheet to extend therethrough. The intermediate abutment may include a wedge shaped member located over each aperture. This wedge shaped member may be resiliently supported on the support plate and therefore movable relative thereto. The abutment of the rider member can be urged against the wedge shaped member thereby pressing the member against the bubble and the product located therein. This arrangement can provide a greater mechanical advantage reducing the force required to eject the product from the bubble sheet.

The ejection means may further include a ratchet mechanism for preventing any motion of the rider member except in the forward direction. Therefore, any actuation motion of the actuation arm in an initial forward and subsequent rearward motion would result in only a forward movement of the rider member, with the rider member moving under the next bubble in the bubble wrapped sheet to thereby eject the product contained therein. This can continue until such times that the rider member reaches the end of its travel along the actuation arm.

The ratchet mechanism may include a plurality of flexible fingers extending from the actuation arm. Each flexible finger may extend at an acute angle from the plane of the actuation arm and may all point towards the forward direction of the actuation arm. The rider member can move in the forward direction over the top of each finger because of the flexibility of each finger. Each finger may act to push the rider member along the actuation arm, the fingers being spaced therealong to ensure that the rider member can sequentially move under each respective product in the bubble wrapped sheet. The fingers however prevent any rearward motion of the rider member back along the actuation arm. Flexible ratchet fingers may also be provided on a side guide wall of the support frame adjacent each actuation arm. These ratchet fingers may also extend at an acute angle from the plane of the side guide wall and may point in the forward direction of the actuation arm. These ratchet fingers also help to prevent the rider member from moving back along the actuation arm when it moves back in the rearward direction back to its initial position.

Each actuation arm may include a finger rest on one end thereof. This finger rest may be located in an exposed position on the outside of the dispensing means. A person using the dispenser can then displace the actuation arm by applying a force on the finger rest to thereby move the actuation arm. A removable spacer may be provided between the finger rest and an opposing shoulder on the dispensing assembly. This spacer prevents motion of the actuation arm until the spacer is removed from between the finger rest and the shoulder. The removal of the spacer also provides a further indication of any tampering of the dispenser.

It is to be appreciated that the ejection means can also eject more than one product at any one time. For example, a single actuation arm may support a rider member having two abutments located side by side. The movement of the rider member results in the ejection of two products located side by side in the bubble wrapped sheet.

According to a second preferred embodiment of the present invention, the outer cover may be pivotally supported on the dispensing assembly, the outer cover being located over the portion of the dispensing assembly from which the product is dispensed. The tamper indication means may prevent pivotal motion of the outer cover away from the dispensing assembly which could allow access to the product located therein. This embodiment may utilise a dispensing assembly including an ejection means similar to the earlier described embodiment. The ejection means may include at least one slide mechanism including an actuation arm upon which is slidably mounted a rider member adapted to eject the product. Furthermore, the ejection means may similarly include a ratchet mechanism for limiting the motion of the rider member towards the said forward direction.

According to the second preferred embodiment, the outer cover may be operably interconnected with the ejection means such that pivotal movement of the outer cover away from the dispensing assembly may result in at least substantially simultaneous actuation of the ejection means. The pivotal motion of the outer cover may displace the or at least one of the actuation arms thereby displacing the rider member supported thereon, The ratchet mechanism may limit the motion of the rider member towards the forward direction. The outer cover may be pivotally connected adjacent one end thereof using, for example, stub axles extending laterally from opposing sides of the outer cover. That end of the outer cover may be further interconnected by a coupling arrangement to the or each actuation arm. The coupling arrangement may include at least one pivot pin engaged to a cooperating slot arrangement. The or each pivot pin may have a pivot axis extending at least substantially parallel to the pivot axis of the outer cover, and may be supported on an adjacent the said one end of the outer cover. The cooperating slot arrangement may be provided on a rear end of the actuation arm. As the pivot pin may be engaged to the slot arrangement pivotal movement of the outer cover away from the dispensing assembly will result in displacement of the pivot pin within the slot arrangement thereby urging the actuation arm in the forward direction, with the outer cover acting as a lever, the fulcrum being the pivot connection of the outer cover to the dispenser assembly. Pivotal displacement of the outer cover back to its initial position against the dispensing assembly results in the actuation arm being retracted back to its initial position prior to actuation thereof.

The tamper indication means may be provided on the opposing end of the outer cover to the coupling arrangement. The tamper indication means may be similar in construction to that described in the Applicant's co-pending International patent application No. PCT/AU01/00844 filed on Jul. 13, 2001. Details of this application are incorporated therein by reference. In particular, the tamper indication means may include a locking element(s) separable from the product dispenser to thereby allow displacement of the outer cover from the dispensing assembly, the removal of the locking element(s) further providing a visual indication that the product dispenser has been opened.

The locking element(s) may be adapted to allow an initial engagement of the outer cover when located over the dispensing assembly while preventing subsequent removal therefrom.

The locking element(s) may include a locking tab which may be integrally formed with the outer cover by a frangible connection. The locking tab may cooperate with a child proofing means for preventing a child from readily moving the outer cover thereby preventing access to the product contained therein.

The child proofing means may include an engagement means for engaging the outer cover to the dispensing assembly. The engagement means may include a manual actuator mechanism having a biased latch. A coupling arrangement may be provided between the outer cover and the dispensing assembly which may be released by movement of the biased latch. The coupling arrangement may include one or more lugs supported on the manual actuator mechanism for engaging one or more apertures provided in the outer cover. The apertures may be provided in tags extending from an inner face of the outer cover. With the outer cover located over the dispensing assembly, the locking tab may prevent movement of the latch thereby preventing the release of the outer cover from the dispensing assembly.

The latch may extend through an aperture provided in the outer cover, with the locking tab forming one side of the aperture. Removal of the locking tab provides clearance to allow the latch to be moved thereby enabling the outer cover to be opened.

It will be convenient to further describe the invention with respect to the accompanying drawings which illustrate preferred embodiment's of the tamper proof dispenser according to the present invention. Other embodiments of the dispenser are also possible, and consequently, the particularity of the accompanying drawings is not to be understood as superceding the generality of the preceding description of the invention. in the drawings:

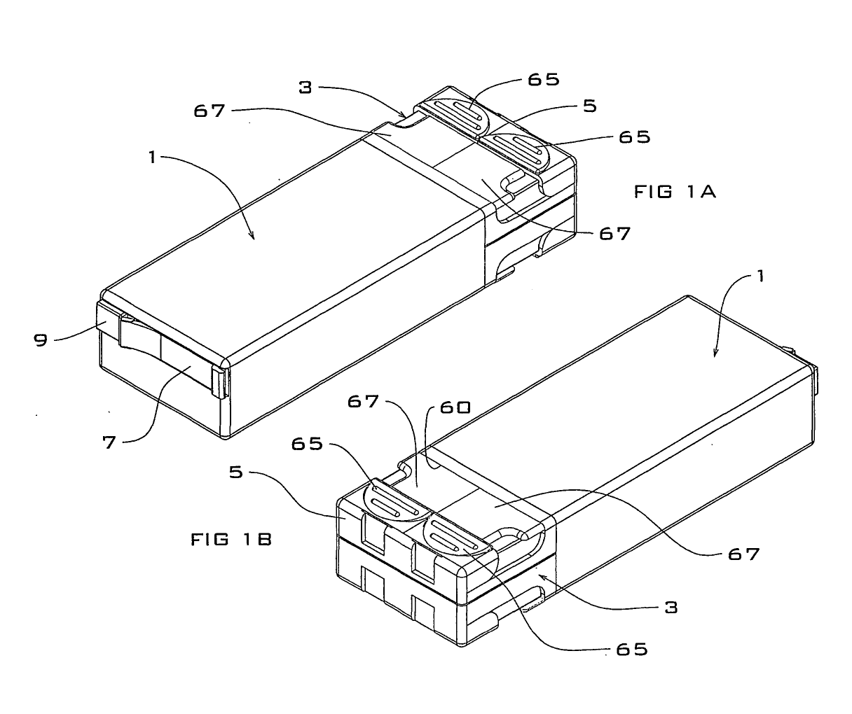

FIGS. 1a and b are respective isometric views of a first preferred embodiment of a dispenser according to the present invention in a closed state;

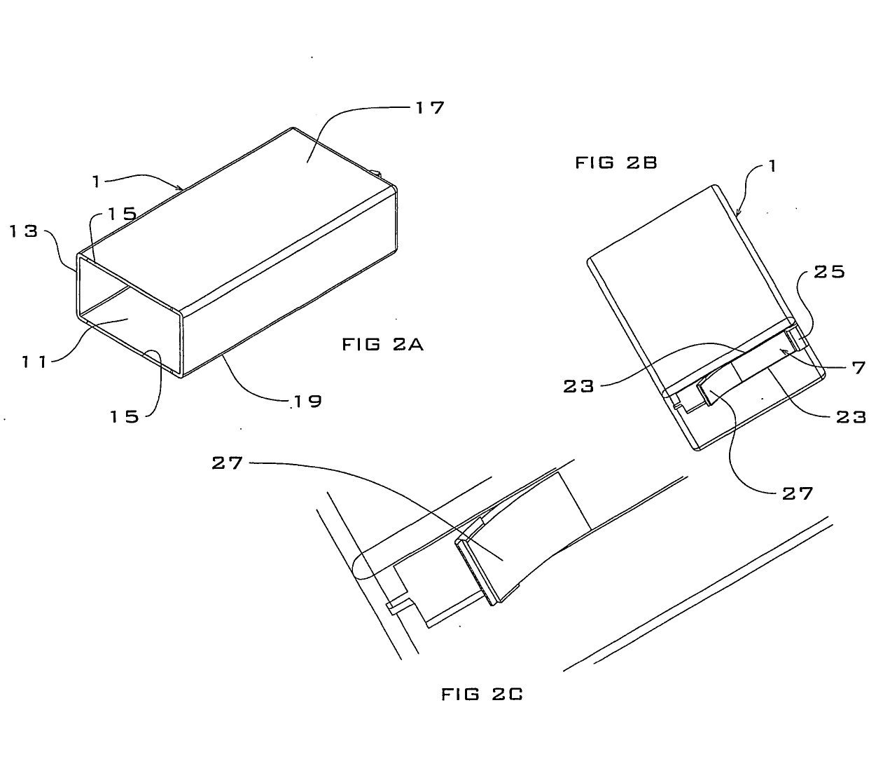

FIGS. 2a to c are respectively isometric and a detailed view of an outer cover of the dispenser of FIGS. 1a and b;

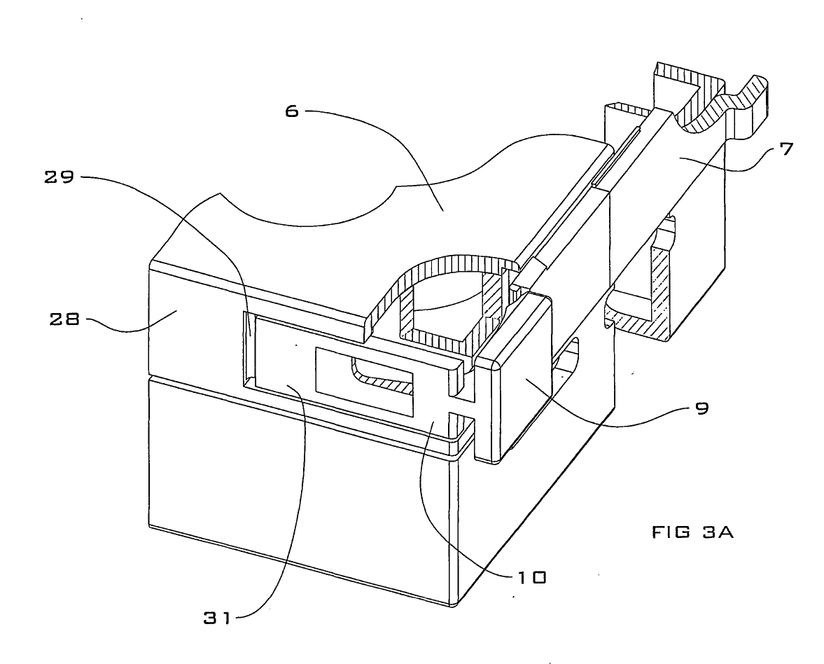

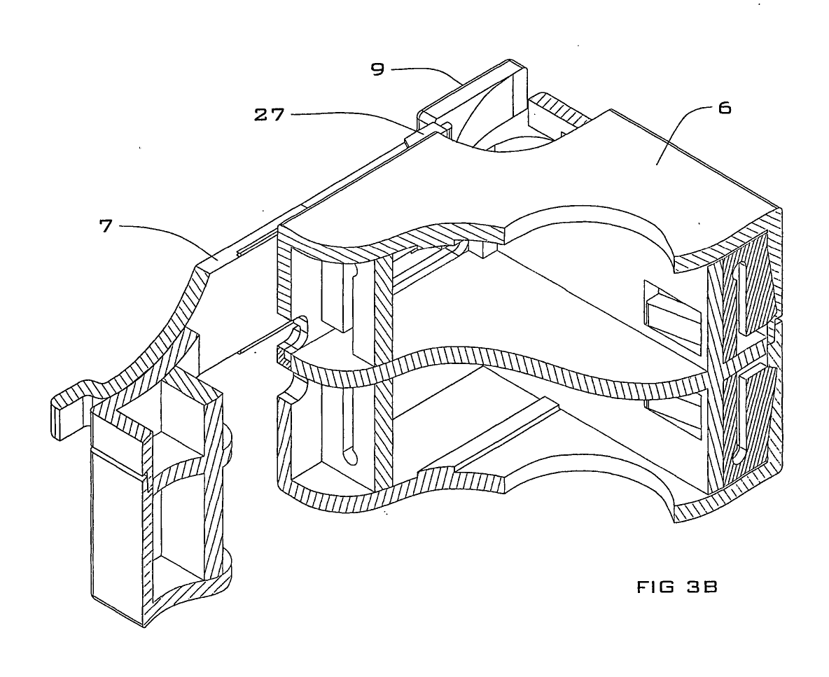

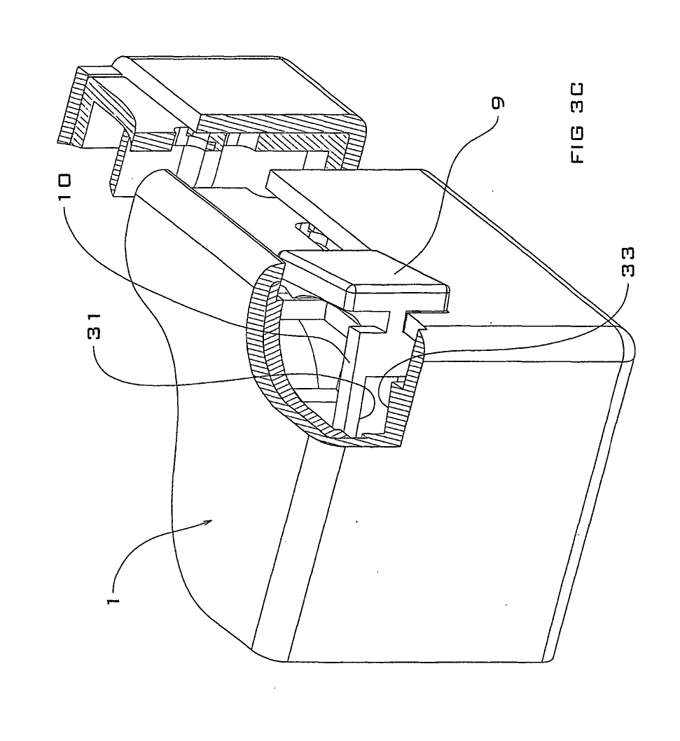

FIGS. 3a to c are respective detailed views of the dispensing means of the dispenser of FIGS. 1a and b;

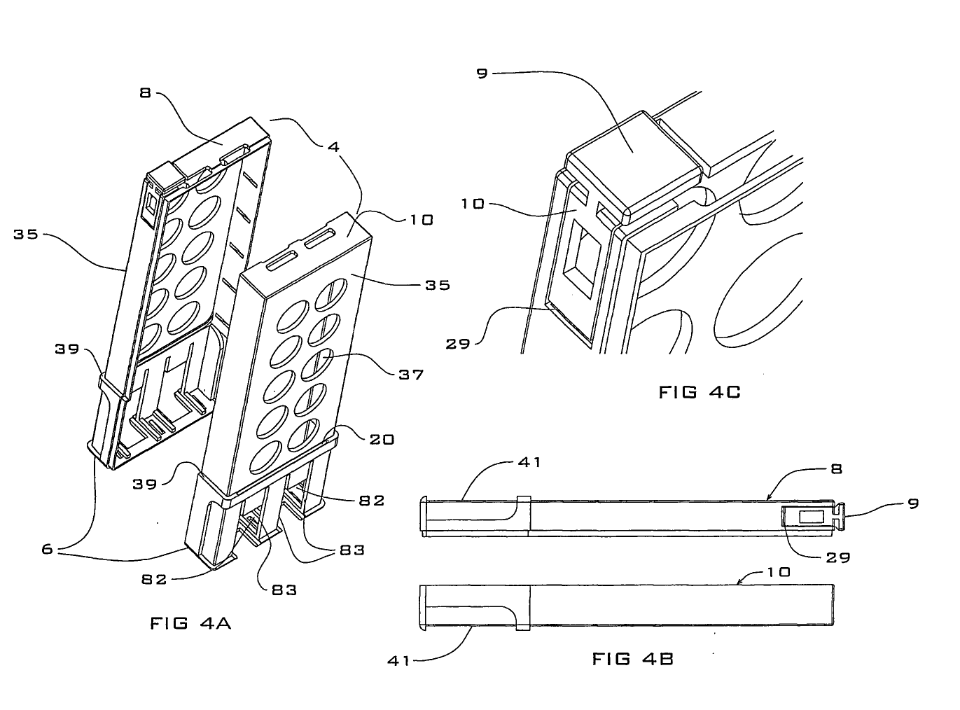

FIGS. 4a to c are respectively an isometric, side and detailed view of the outer shell of the dispensing assembly of FIGS. 3a to c;

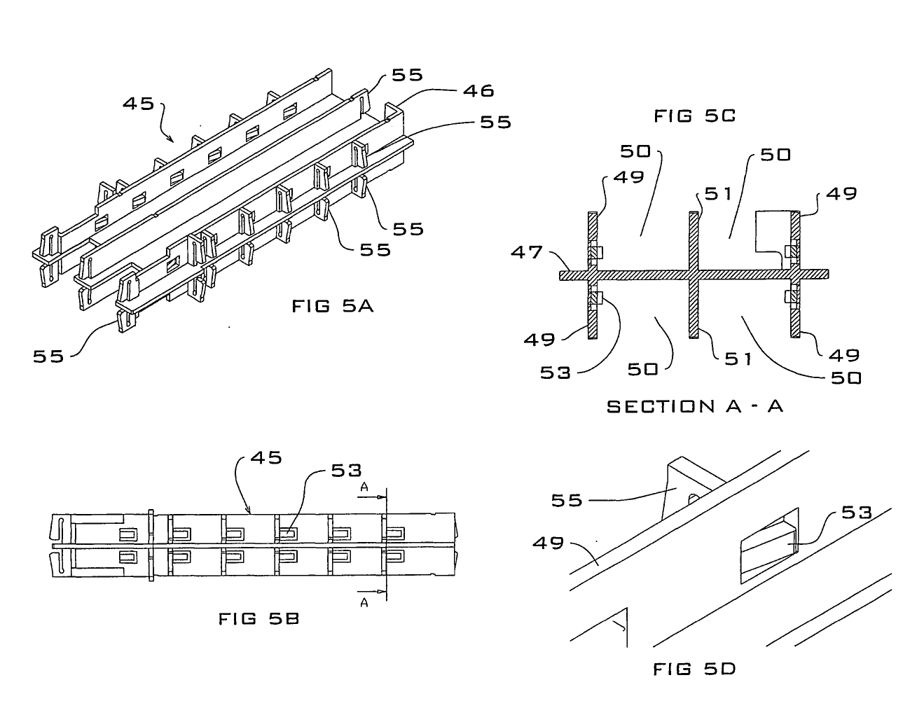

FIGS. 5a to d are respectively isometric, side, end and a detailed view of the support frame located within the outer shell of FIGS. 5a to c;

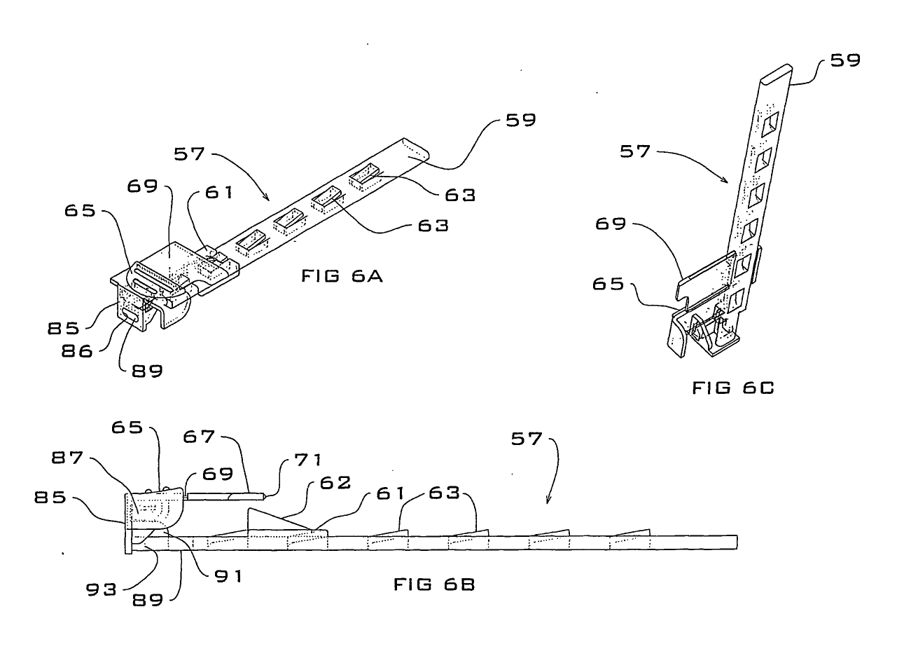

FIGS. 6a to c are respectively isometric and a side view of a slide mechanism located on the support frame of FIGS. 5a to d; and

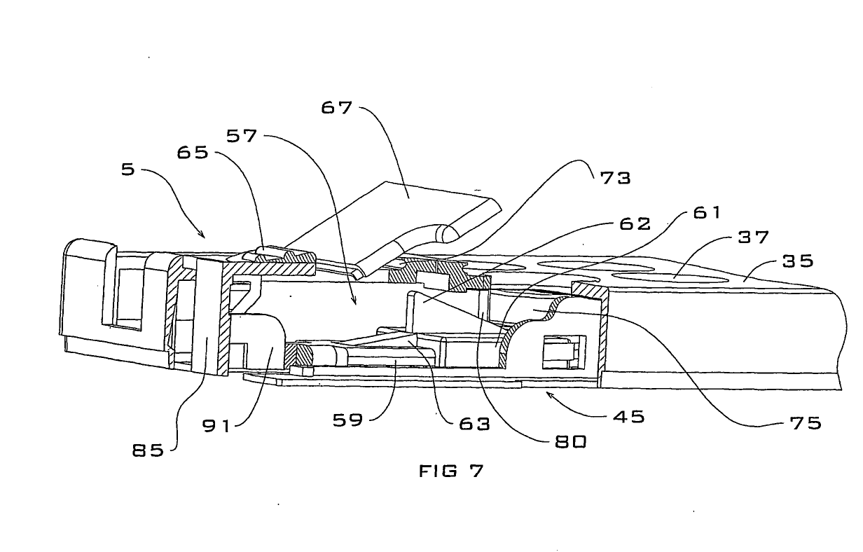

FIG. 7 is an isometric partially cross-sectional view of a dispensing assembly of the dispenser of FIGS. 1a and b;

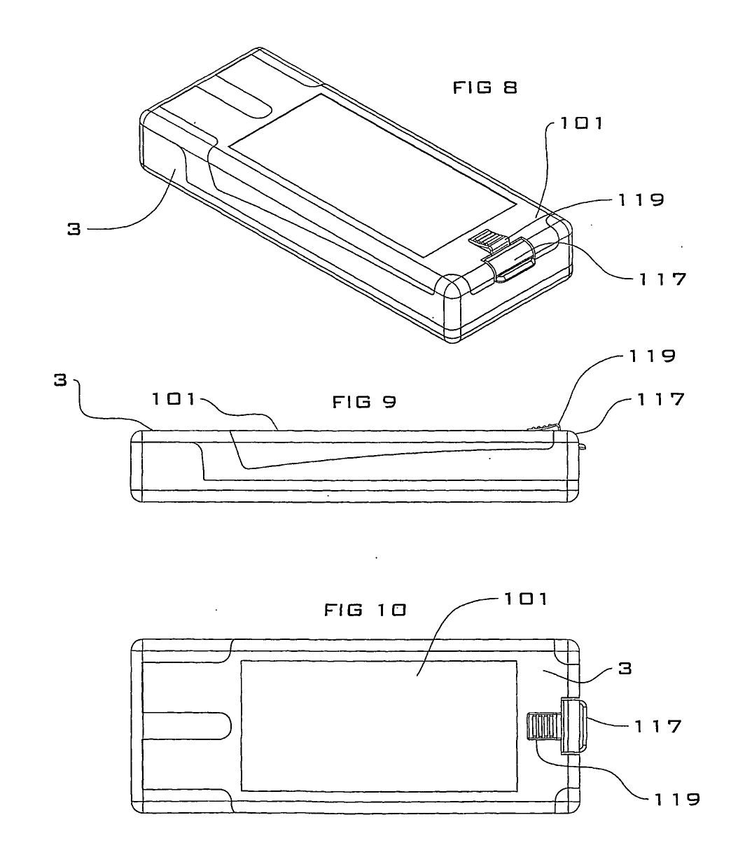

FIGS. 8 to 10 are respectively isometric, side and plan views of a second preferred embodiment of a dispenser according to the present invention in a closed state;

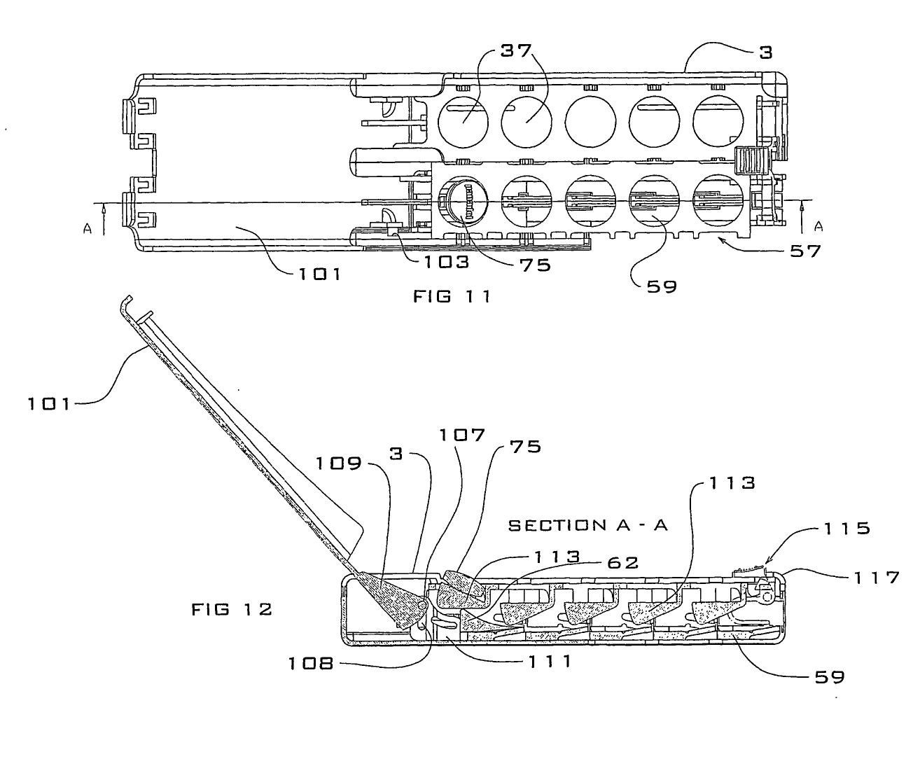

FIG. 11 is a plan and partial cross-sectional view of the dispenser of FIG. 8 with the outer cover open;

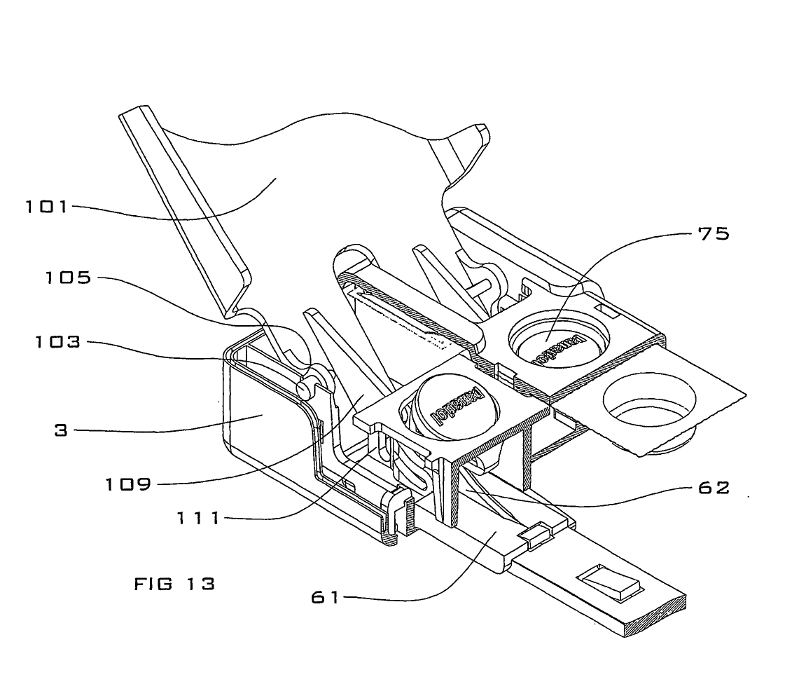

FIG. 12 is a side cross-sectional view through section A-A of FIG. 11;

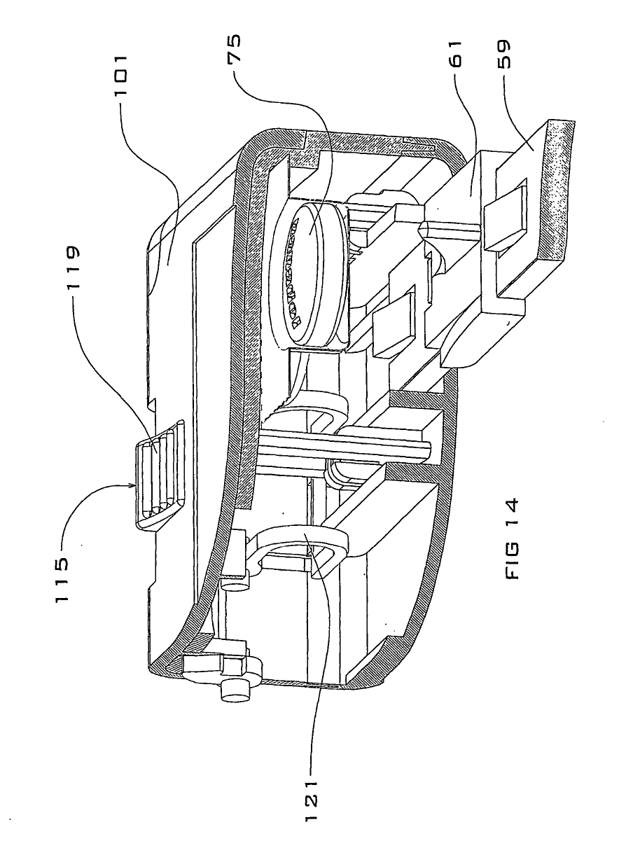

FIGS. 13 and 14 are respectively detailed isometric views of the dispenser of FIG. 8;

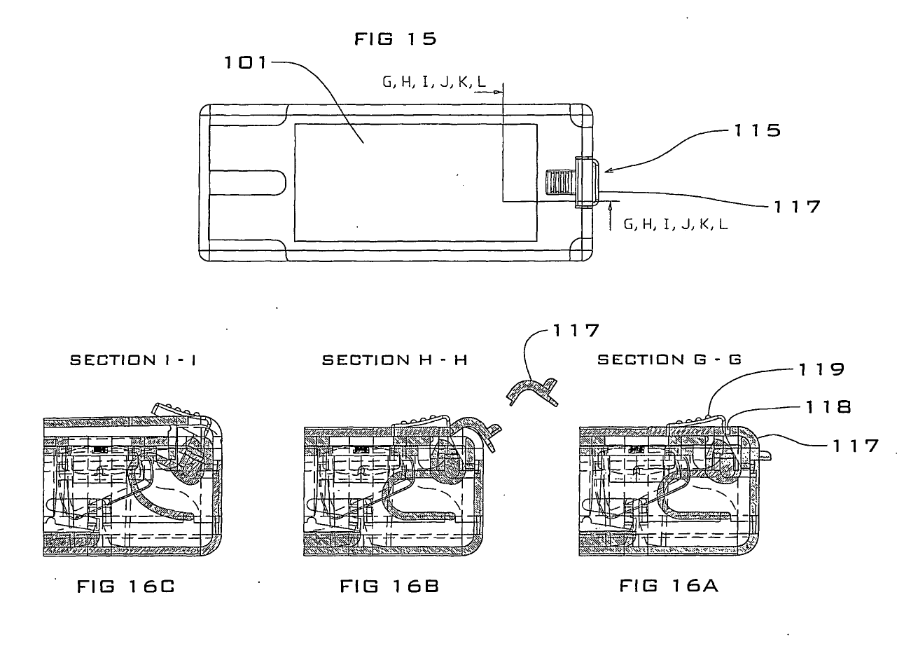

FIG. 15 is a plan view of the dispenser of FIG. 8;

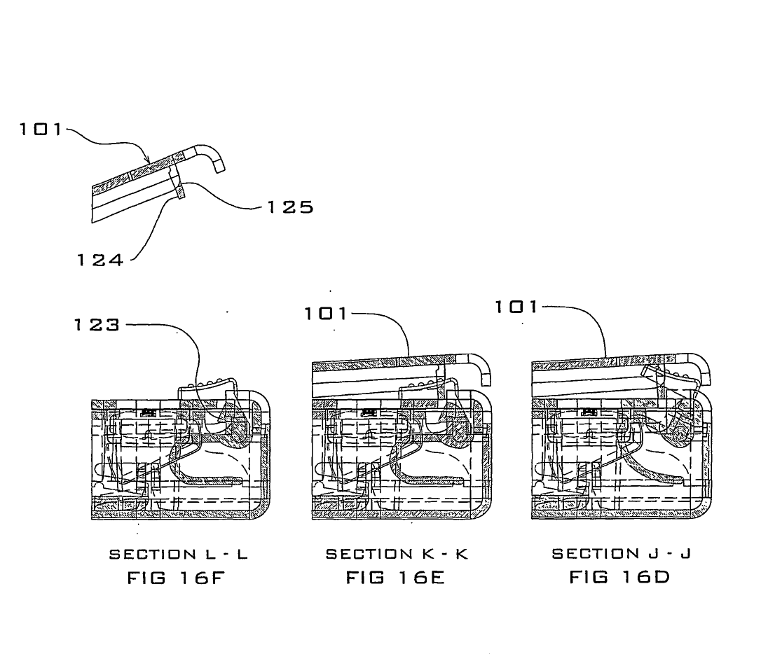

FIGS. 16a to 16f are a detailed cross-sectional view taken along the section lines shown in FIG. 15

Referring initially to FIGS. 1a and b, the first preferred embodiment of the dispenser according to the present invention includes an outer cover 1 covering a dispensing portion of a dispensing assembly 3. FIGS. 1a and b shows the dispenser in a closed position with only an outer end 5 of the dispensing assembly 3 being visible when the cover 1 is located thereon.

The dispenser includes a tamper indication means in the form of a removable elongate tag 7, the operation of which will be subsequently described. Furthermore, the dispenser includes a child proofing means which includes an external button 9 located at one end of the dispenser. The operation of the child proofing means will also be subsequently described.

The outer end 5 supports four separate finger rests 65, two on each side of the dispenser. These finger rests 65 allow the dispensing assembly 3 to be actuated. A respective spacer member 67 is provided between each finger rest 65 and a shoulder 60 provided on the dispensing assembly 3. Each spacer member 67 including a lateral tab 68 to allow that spacer member 67 to be lifted and separated from the dispensing assembly. The operation of the finger rests 65 and spacer members 67 will be subsequently described.

FIGS. 2a to c provide further details of the outer cover 1 which is slideably supported over the dispensing portion of the dispensing assembly 3. To this end, the outer cover 1 includes an entrance opening 11 through which the dispensing portion of the dispensing assembly 3 can enter the cover 1. The peripheral edge 13 of the entrance opening 11 is also provided with a seal rib 15 located adjacent a top face 17 and bottom face 19 of the cover 1. These seal ribs 15 are accommodated within a cooperating groove 20 (shown in FIG. 4a) provided on a shoulder 39 of the dispensing assembly 3. This sealing arrangement prevents the ready access of a hypodermic needle between the junction of the outer cover 1 and the dispensing assembly 3 when the dispenser is closed.

FIGS. 2b and c show in more detail the tamper indication tag 7. This tag 7 can be integrally formed with the rest of the outer cover 1 and may be secured thereto by a frangible tear zone 23 along opposing elongate edges of the tag 7. One end of the tag is provided with a tab 25 which is raised above the surface of the outer cover 1 and allows a user of the dispenser a means to lift the tag 7 away from and thereby separate the tag 7 from the rest of the outer cover 1.

At the opposing end of the tag 7 from the tab 25 is provided a raised abutment finger 27 which is located under the button 9 of the child proofing means when the dispenser is initially assembled. This abutment finger 27 prevents any substantial movement of the button 9 until the elongate tag 7 is removed from the outer cover 1.

FIGS. 3a and b show in more detail the interaction between the elongate tag 7 and the button 9. FIGS. 3a and b show the arrangement at the end of the dispensing portion 6 of the dispensing assembly 3 with the outer cover otherwise not shown except for the tag 7. The button 9 is supported on a tongue 10 which is hingedly supported by a flexible hinge 29 to a side wall 28 of the dispensing portion 6. The tongue 10 is provided with an aperture 31. When the elongate tag 7 is in position as shown in FIG. 3a, the button 9 is prevented from any significant pivotal movement about the flexible hinge 29 because of the abutment finger 27 resting against the underside of the button 9. This is more clearly shown in FIG. 3b which provides a view of the tag 7, button 9 and abutment finger 27 when viewed from the interior of the dispenser.

When the tag 7 is removed, then the button 9 is able to move inwards as shown in FIG. 3c. Also shown in FIG. 3c is the outer cover 1, which is provided with an internal lug 33. This lug 33 is aligned with the aperture 31 of the tongue 10 when the cover 1 is in a closed position over the dispensing assembly 3. When the button 9 is in the position shown in FIGS. 3a and b, the aperture 31 accommodates the lug 33 to thereby prevent the cover 1 sliding off the dispensing portion 6. However, following the removal of the tag 7, the button 9 can be moved inwards thereby releasing the tongue aperture 31 from the lug 33 of the outer cover 1. This then allows the cover 1 to be removed from the dispensing portion 6.

The elongate tag 7 therefore provides a tamper indication means for the dispenser according to the present invention. The removal of this tag 7 provides a visual indication of the opening of the dispenser. Furthermore, the arrangement of the button 9 and the cooperation of the tongue aperture 31 with the lug 33 of the outer cover 1 provides a child proofing means for the dispenser according to the present invention. A young child would not readily appreciate that it is necessary to deflect the button 9 inwards while at the same time sliding open the cover 1.

FIGS. 4a to 4c provide further details of the construction of the dispensing assembly 3. This assembly includes an outer shell 4 formed of two half shells 8, 10. Each half shell includes a dispensing face 35 through which is provided a plurality of openings 37. These openings are sized and spaced to correspond with the location of a single dosage product in a conventional bubble wrapped sheet. When the two half shells 8, 10 are assembled, the dispensing face 35 is provided on the dispensing portion 6 of the dispensing assembly 3. Each half shell 8, 10 further includes an abutment shoulder 39 upon which the outer cover 1 can abut when closed. To this end, the groove 20 shown in FIG. 4a engages the seal rib 15 shown in FIG. 2a. One half shell 8 is provided with the button 9, tongue 10 and flexible hinge 29 of the child proofing means. The half shells 8, 10 also provide the outer end 6 of the dispensing assembly 3 which is not covered by the outer cover 1.

The section of each half shell 8, 10 which form the outer end 6 of the dispensing assembly 3 are provided with two parallel slots 82, each slidably accommodating the finger rests 65 shown in FIGS. 1a and b when the dispenser is assembled. The finger rests 65 are adapted to engaging the opposing peripheral edge of each slot 82.

FIGS. 5a to 5d show a support frame 45 which is accommodate within the assembled half shells 8, 10. This support frame 45 includes a central plate 47. From each side of the central plate 47 extends two parallel side guide walls 49 and a central guide wall 51. These guide walls 49, 51 together with the central plate 47 together define slide passages 50, two on each side of the central plate 47. The side guide walls 49 further include a plurality of flexible fingers 53 extending along the length of the guide wall 49. Each finger extends at an acute angle from the plane of the side guide wall 49 and point in the same direction. These flexible fingers 53 provide part of a ratchet mechanism as will be subsequently described.

Along the peripheral edge of the support frame 45 are provided a plurality of resilient retainers 55. These resilient retainers 55 may be integrally formed as part of the support frame 45 and act to retain and lock the support frame 45 in position within the outer shell 4 of the dispensing assembly 3 when located therein.

The support frame 45 further includes a fire wall 46 which is located behind the button 9 when in the installed position. This fire wall 46 provides a further barrier to any attempted access of a hypodermic needle from behind that button 9.

Each slide passage 50 accommodates an actuation mechanism 57 as shown in FIGS. 6a to c. This actuation mechanism 57 includes an actuation arm 59 upon which is supported a rider member 61. Located on the rider member 61 is an abutment 62 which is shown in the form of a ramp. The actuation arm 59 further includes a plurality of flexible fingers 63 extending along the length of the actuation arm 59. Each flexible finger 63 extends at an acute angle from the plane of the actuation arm 59 and point in a “forward” direction of the actuation mechanism 57, being towards the end of the dispensing portion 6. When the actuation mechanism 57 is located within the slide passage 50, the flexible fingers 53 of the side guide walls 49 point in the same forward direction as the flexible fingers 63 of the actuation arm 59. Both the flexible fingers 63 of the actuation arm 59 and the flexible fingers 53 of the side guide walls 49 together provide a ratchet mechanism for the dispensing assembly 3.

The actuation mechanism 57 further includes the finger rest 65 shown in FIGS. 1a and b located at a rear end of the actuation arm 59.

The finger rest 65 is located on an exposed surface of a connector member 85 adapted to connect to one end of the actuation arm 59. This connection member 85 includes a slot 86 for accommodating an end portion 89 of the actuation arm 59 which is narrower than the rest of that arm. A hook 91 extends from that connector member 85 for engaging a slot 93 provided in the actuation arm end portion 89. On opposing sides of the connector member 85 are provided flexible lugs 87. These lugs 87 have sufficient flexibility to allow the connector body 85 to be pushed into a respective slot 82 of the dispensing assembly 3, with the flexible lugs 87 deflecting inwardly and being retained under the peripheral edge 83 thereof. At the same time, the connector member 85 connects to the actuator arm end portion 89 by means of the hook 91 and slot 86. The connector member 85 can then move as a unit together with the actuation arm 59.

The spacer member 67 shown in FIGS. 1a and b is located in a position forward of the finger rest 65. Furthermore, the spacer member 67 is attached by a frangible connection 69 to the finger rest 65. An engagement rib 71 is provided at the opposing end of the spacer member 67. This engagement rib 71 cooperates with an engagement groove 73 (shown in FIG. 7) provided on the shoulder 60 of the dispensing assembly 3 when the actuation mechanism 57 is installed in the dispensing assembly 3. The spacer member 67, when resting flush on the outer end 5 of the dispensing assembly 3 blocks any movement of the finger rest 65, and therefore the rest of the actuation mechanism 57.

FIG. 7 shows in more detail the dispensing assembly 3 when assembled. In particular, FIG. 7 shows a partial cross-sectional view of the dispensing assembly 3 showing the actuation mechanism 57 supported within the support frame 45. Also shown is the rider member 61 in its initial position on the actuation arm 59 prior to ejection of the first single dosage product 75. The spacer member 67 must initially be removed and separated from the finger rest 65 to enable the actuation mechanism 57 to be moved. FIG. 7 shows the spacer member 67 in a partially separated position. Following the removal of the spacer member 67, the actuation arm 59 can move forwards by applying finger pressure on the finger rest 65. The actuation arm flexible finger 63 urges the rider member 61 in the forward direction such that the rider member abutment 62 is pushed under the first single dosage product 75, a portion of which is shown in FIG. 7. This product 75 is in the form of a tablet supported within a bubble of a bubble wrapped sheet 80. This sheet 80 is located with the foil face thereof facing the openings 37 of the dispensing face 35. As the rider member 61 is urged forward, the abutment 62 pushes the product 75 from the supporting bubble, through the foil and out the opening 37.

At the end of the ejection process, the guide wall flexible fingers 53 prevent the return of the rider member 61 to its initial position. The guide wall flexible fingers 53 press against the rider member 61 to prevent any rearward movement while the next actuation arm flexible finger 53 is allowed to slide under and behind the rider member 61. That subsequent actuation arm flexible finger 63 can therefore push the rider member 61 forward at the next ejection process. The rider member 61 therefore progresses along the actuation arm 59 until all of the product 75 located adjacent the actuation mechanism 57 has been ejected. The next row of product 75 can then be ejected in the same manner.

FIGS. 8 to 16f are directed to a second preferred embodiment of the present invention. Features corresponding to features of the first described embodiment are designated with the same reference numerals for clarity reasons.

The principal difference is that, in place of the slidably mounted outer cover, there is used an outer cover 101 which is pivotally supported on the dispenser assembly 3. The outer cover 101 covers the opening 37 provided in the dispensing assembly 3 from which the product 75 is dispensed.

The outer cover 101 is pivotally mounted on the laterally extending stub axles 103 mounted in pivot points 105 provided within the dispensing assembly 3 providing a pivotal connection from the outer cover 101 (best shown in FIG. 13). At that end of the outer cover are also provided pivot pins 107 that are mounted on brackets 109 extend from the inner face of the outer cover 101. The pivot pins 107 are respectively accommodated within a corresponding slot 108 provided in a bracket 111 located at a rear end of the actuation arm 59 of the actuation mechanism 57 (best shown in FIG. 12). A pivotal displacement of the outer cover 101 away from the dispensing assembly 3 about the pivotal connection results in a displacement of the actuation arm 59 in the forward direction. The actuation mechanism 57 works in the same way as the first preferred embodiment, with the forward movement of the actuation arm 59 resulting in the ejection of the product 75 from the dispensing assembly. Supported on 59 each actuation arm is a rider member 61 having an abutment 62. The abutment 62 engages resiliently mounted wedge shaped member 113 which is then urged against the product 75 to displace it from the bubble wrap sheet (best shown in FIGS. 12 and 13). The actuation mechanism 59 uses the same ratchet mechanism as in the earlier embodiment and will not be described again. This arrangement therefore allows for at least substantially simultaneous opening and dispensing of product 75.

The other principal difference of the present embodiment from the earlier described embodiment is the tamper indication means and the child proofing means. FIGS. 14 to 16f best show this arrangement which is located at the opposing end of the outer cover 101 to the pivotal end thereof.

The child proofing means includes a manual actuator mechanism 115, and the tamper indication means includes a locking tab 117. The manual actuator mechanism 115 includes a biased latch 119 supported on a resilient mount 121. Supported on the actuator mechanism 115 and lugs 123 which engage cooperating apertures 125 provided on tags 124 extending from an inner face of the outer cover 101.

The child proofing means operates by the movement of the biased latch which releases the lugs 123 from the cooperating apertures 125 thereby releasing the outer cover 101. The movement of the biased latch 119 is however blocked by the locking tab 117. This locking tab is integrally formed with the outer cover 101 with a frangible connection 118 being provided between the locking tab 117 and the rest of the outer cover 101. The outer cover 101 cannot therefore be opened until the locking tab 117 is removed. The removal of this locking tab 117 provides the visual indication of the prior opening of this product dispenser.

FIGS. 16a to 16f show the sequence of operation of the tamper indication means and child proofing means. Following removal of the locking tab 117 (FIG. 16b), the biased latch 119 can be displaced (FIG. 16c) releasing the outer cover (FIGS. 16d to 16f).

The dispenser according to the present invention provides a tamper indication means which allows a person to be aware that the dispenser has been opened. Furthermore, according to the preferred embodiments described herein, the dispenser can also provide child proofing means to prevent the ready opening of the dispenser by a young child after the tamper indication means has been removed. Furthermore, the solid dosage product stored within the dispenser can be hygienically ejected without any human contact reducing the possibility of bacterial or other contamination of the product.

Modifications and variations as would be deemed obvious to the person skilled in the art are included within the ambit of the present invention as defined in the appended claims.

1. A tamper proof product dispenser for a solid dosage product comprising:
a dispensing assembly for holding and dispensing the product;
an outer cover for covering at least a portion of the dispensing assembly to thereby prevent access to the product stored therein; and
tamper indication means for indicating a prior displacement of the outer cover, wherein the dispensing assembly includes ejection means located within the dispensing assembly for ejecting the solid dosage product therefrom, the ejection means comprising at least one slide mechanism having an actuation arm upon which is slidably mounted a rider member adapted to eject the product.

2. A tamper proof product dispenser according to claim 1 wherein the dispenser is adapted to accommodate a plurality of individual units of solid dosage product.

3. A tamper proof product dispenser for a solid dosage product wherein the solid dosage product is in the form of a plurality of discrete product units arranged in at least one row, the dispenser comprising a housing, a cover and a dispensing assembly, the housing having at least one outlet for dispensing the product; the outer cover adapted for covering at least a portion of the housing to thereby prevent access to the at least one outlet, and tamper indication means for indicating a prior displacement of the outer cover, the dispensing assembly comprising at least one actuating arm accommodated within the housing and associated with one of the at least one rows and adapted for reciprocating movement relative to the elongate axis of said row, the actuating arm slidably engaging a rider member associated with said row and operative to positionally index said rider member at each cycle of reciprocating movement of said actuating arm through a number of positions in one to one correspondence with the number of product units in the row, said rider member being caused to move into an engaging relationship with a successive unit of said solid dosage product within said row on each cycle of movement of the actuating arm to thereby eject the unit of said solid dosage product through the outlet, the actuating arm being associated with a member operable from outside of the dispensing assembly to reciprocally actuate said actuating arm.

4. A tamper proof product dispenser according to any one of the preceding claims, wherein the dispenser is adapted accommodate at least one solid dosage product bubble wrapped sheet, each sheet including a plastic membrane having a plurality of depressions to provide a cavity within which each solid dosage product is respectively located, and an aluminium foil covering the plastic membrane to thereby seal the product therein.

5. A tamper proof product dispenser according to claim 4, wherein the dispensing assembly includes an outer shell for accommodating one or more of the sheets.

6. A tamper proof product dispenser according to claim 5, wherein a plurality of openings are provided through the outer shell through which the product may exit the dispensing means, the or each bubble wrapped sheet being located within the shell, with the foil side of the sheet facing the openings, these openings being aligned with a respective cavity of the sheet.

7. A tamper proof product dispenser according to claim 6, wherein the shell is adapted to accommodate two said sheets therein, with the said openings being on opposing sides of the shell. the plastic membrane side of each sheet facing inwardly towards each other, the foil side of each sheet facing the openings in the outer shell.

8. A tamper proof product dispenser according to any one of the preceding claims, wherein a plurality of said actuation arms are located within the dispensing assembly, a said actuation arm being located adjacent an associated row of solid dosage product accommodated in the dispensing assembly.

9. A tamper proof product dispenser according to claim 8, wherein the actuation arms are slidably supported by an inner support frame located within the dispensing assembly.

10. A tamper proof product dispenser according to any one of the preceding claims, wherein an abutment extends from the rider member, the actuation arm being movable both forward and backwards in a direction parallel to the elongate axis thereof, whereby the motion of the actuation arm moves the rider member and urges the abutment of the rider member against a said solid dosage product so that product can be ejected out of the dispensing assembly to thereby dispense that product therefrom.

11. A tamper proof product dispenser according to any one of claims 1 to 9, wherein a resiliently supported wedge shaped intermediate abutment member is located adjacent each solid dosage product, an abutment extends from the rider member, the actuation arm being movable both forward and backwards in a direction parallel to the elongate axis thereof, whereby the motion of the actuation arm moves the abutment of the rider member against an intermediate abutment member such that a said solid dosage product is urged by the intermediate member and ejected out of the dispensing assembly to thereby dispense that product therefrom.

12. A tamper proof product dispenser according to claims 10 or 11, wherein the ejection means further includes a ratchet mechanism for limiting the motion of the rider member towards the said forward direction.

13. A tamper proof product dispenser according to claim 12, wherein the ratchet mechanism includes a plurality of flexible fingers extending from the actuation arm, each flexible finger extending at an acute angle from the plane of the actuation arm and all pointing towards the forward direction of the actuation arm, the rider member being movable in the forward direction over the top of each finger, with each finger acting to push the rider member along the actuation arm.

14. A tamper proof product dispenser according to claim 13, wherein flexible ratchet fingers are provided on a side guide wall of the support frame adjacent the or each actuation arm, the ratchet fingers extending at an acute angle from the plane of the side guide wall and pointing in the forward direction of the actuation arm.

15. A tamper proof product dispenser according to any one of the preceding claims, wherein each actuation arm includes a finger rest on one end thereof, the finger rest being located in an exposed position on the outside of the dispensing means, such that the actuation arm can be moved by applying a force on the finger rest.

16. A tamper proof product dispenser according to claim 15, wherein a removable spacer is provided between the finger rest and an opposing shoulder on the dispensing assembly, the spacer preventing motion of the actuation arm until the spacer is removed from between the finger rest and the shoulder.

17. A tamper proof product dispenser according to any one of the preceding claims, wherein the outer cover is slidably supported over the dispensing assembly, and the tamper indication means prevents sliding motion of the cover over the dispensing assembly which will allow access to the product located therein.

18. A tamper proof product dispenser according to claim 17, wherein the tamper indication means is in the form of a removable part of the outer cover, the removable part being coupled to or partially secured to the dispensing assembly, the separation of the removable part releasing the outer cover from the dispensing assembly allowing relative movement therebetween as well as providing a visual indication that the dispenser has been opened.

19. A tamper proof product dispenser according to claim 18, wherein the removable part is in the form of an elongate tag, at least a portion of the opposing sides of the tag being secured to the outer cover, the tag being secured to the outer cover by a frangible membrane.

20. A tamper proof product dispenser according to claim 19, wherein the tag is formed integrally with the outer cover.

21. A tamper proof product dispenser according to claim 19 or 20, wherein one end of the elongate tag is provided with a raised ledge that is positioned away from an outer surface of the outer cover, the ledge providing a means whereby a person can lift the end of the tag away from the rest of the dispenser to thereby separate the rest of the tag therefrom, the opposing end of the elongate tag being coupled to the dispensing assembly and being uncoupled therefrom when the elongate tag is removed from the dispenser.

22. A tamper proof product dispenser according to claim 21, wherein the opposing end of the elongate tag is located under an undercut provided on the dispensing assembly when coupled thereto.

23. A tamper proof product dispenser according to any one of the preceding claims, further including child proofing means for preventing a child from readily moving the cover thereby preventing access to the product contained therein.

24. A tamper proof product dispenser according to claim 23, wherein the child proofing means includes a button mounted on the end of a tongue, the other end of the tongue being hingedly connected to the rest of the dispensing assembly, and means for engaging the outer cover.

25. A tamper proof product dispenser according to claim 24, wherein the engagement means is in the form of a male lug provided on an inner surface of the outer cover, with a cooperating aperture or cavity being provided in the tongue, the lug being captured within the aperture or cavity in the tongue when the cover is closed over the dispensing assembly, such that pivotal displacement of the tongue away from the lug by applying a lateral force on the button releases the aperture or cavity of the tongue from the lug thereby allowing movement of the cover over the dispensing assembly.

26. A tamper proof product dispenser according to claim 25, wherein a portion of the tamper indication means is located under an edge of the button to prevent movement thereof until such times as the tamper indication means is separated from the outer cover.

27. A tamper proof product dispenser according to any one of claims 1 to 16, wherein the outer cover is hingeably supported adjacent one end thereof on the dispensing assembly, the tamper indication means preventing pivotal motion of the outer cover away from the dispensing assembly which would allow access to the product located therein.

28. A tamper proof product dispenser according to claim 27, wherein the tamper indication means is in the form of a removable part of the outer cover, the separation of the removable part therefrom enabling the outer cover to be pivotally displaced away from the dispensing assembly.

29. A tamper proof product dispenser according to claim 28, further including a child proofing means for preventing a child from readily moving the outer cover thereby preventing access to the product contained therein.

30. A tamper proof product dispenser according to claim 29 wherein the child proofing means includes an engagement means for engaging the outer cover to the dispensing assembly.

31. A tamper proof product dispenser according to claim 30, wherein the engagement means includes one or more tags extending from an inner face of the cover, said tag(s) forming part of a coupling arrangement for engaging the outer cover of the dispensing assembly.

32. A tamper proof product dispenser according to claim 31, wherein the coupling arrangement includes an aperture provided in the tag(s) for engaging a cooperating lug provided within the dispensing assembly, the lug(s) being resiliently biased and supported on a manual actuator mechanism for allowing the release of the lug(s) from the cooperating tag thereby allowing the pivotal movement of the outer cover from the dispenser assembly.

33. A tamper proof product dispenser according to claim 32, wherein the manual actuator mechanism includes a biased latch, whereby movement of the latch disengages the coupling arrangement.

34. A tamper proof product dispenser according to claim 33, wherein the locking element of the tamper indication means is provided on the outer cover, the locking element preventing movement of the latch thereby preventing the release of the cover from the dispensing assembly.

35. A tamper proof product dispenser according to claim 34, wherein the locking element includes a locking tab located immediately adjacent the latch, the locking tab being connected to the outer cover by a frangible connection.

36. A tamper proof product dispenser according to claim 35, wherein the locking tab is integrally formed with the outer cover with a relatively thin wall section between the locking tab and the rest of the outer cover to provide a frangible connection portion for the locking tab.

37. A tamper proof product dispenser according to any one of claims 27 to 36, wherein the outer cover is hingeably connected adjacent one end of the outer cover, said one end of the cover being further interconnected by a coupling arrangement to the or each actuation arm of the ejection means of the dispensing assembly such that pivotal movement of the outer cover away from the dispenser assembly will result in the displacement of the actuation arm in the forward direction, and such that the return of the outer cover back to its initial position against the dispensing assembly results in the actuation arm being retracted back to its initial position prior to actuation thereof.

38. A tamper proof product dispenser according to claim 37, wherein the coupling arrangement includes at least one pivot pin engaged to a cooperating slot arrangement, the pivot pin being supported on and adjacent the one end of the outer cover, the pivot pin having a pivot axis extending at least substantially parallel to the pivot axis of the outer cover, the cooperating slot arrangement being provided on a rear end of the actuation arm.
